(19) United States
(12) Patent Application Publication
(10) Pub. No.: US 2010/0079673 A1
(43) Pub. Date: Apr. 1, 2010

(54) Video processing apparatus and method thereof

(75) Inventors: Koji Yamamoto, Tokyo (JP); Shunsuke Takayama, Kanagawa (JP); Hisashi Aoki, Kanagawa (JP); Yoshihiro Ohmori, Kanagawa (JP); Kazunori Imoto, Kanagawa (JP); Shuta Ogawa, Kanagawa (JP); Makoto Hirohata, Tokyo (JP); Shigeru Motoi, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/382,567

(22) Filed: Mar. 18, 2009

(30) Foreign Application Priority Data
Sep. 29, 2008 (JP) 2008-250457

(51) Int. Cl. H04N 5/14

(52) U.S. Cl. 348/571; 348/E05.067

(57) ABSTRACT

A video processing apparatus according to the invention detects telops displayed in an entered video, selects specific telops which satisfy arbitrary conditions from among the telops, acquires a plurality of specific telops within an arbitrary time range as one group from among the plurality of specific telops, coordinates two of the specific telops from the group, and extracts a specific segment interposed between the two of the specific telops.

### CROSS-REFERENCE TO RELATED APPLICATION

This application is based upon and claims the benefit of priority from the prior Japanese Patent Application No. 2008-250457, filed on September; the entire contents of which are incorporated herein by reference.

### FIELD OF INVENTION

The present invention relates to a video processing apparatus which is able to extract specific segments for reducing the time to watch programs and a method thereof.

### DESCRIPTION OF THE BACKGROUND

In order to search only scenes that a user wants to watch from a video or in order to produce a digest video, it is necessary to add attribute data to temporal segments in the video. In order to do so, a technique to extract several specific segments which are semantic sections in a video is required.

As one of such techniques, there is a technique to extract segments of actual play scenes only by excluding studio pick-up scenes and the like from a relay broadcasting sports video. For example, JP-A-2008-72232 discloses a method of extracting play segments from a sport video. In the sports video, the segments having a time telop which indicates an elapsed time or a remaining time of a game displaying therein are determined as play segments (specific segments). Specifically, a telop which includes cyclically changing areas is detected as the time telop, and the video is not divided at cut points in the segments from which the telop is detected, so that the play segments are added up as a length of scene.

In the related art described above, since the segments in which the time telop is displayed are recognized as the play segments, such detection is not possible in sports or sport events in which the time telop is not displayed.

For example, in the television program of track and field competition, track events such as a 100 m race and a relay and field events such as a running high jump and a shot-put are mixed in many cases. However, in the field events, the time telop is not displayed (see FIG. 3). Therefore, there is a problem that the field events are missed even when an attempt is made to extract the play segments from such programs.

### SUMMARY OF THE INVENTION

In order to solve the problem in the related art described above, it is an object of the invention to provide a video processing apparatus which is able to detect specific segments without using time telops and a method thereof.

According to embodiments of the invention, there is provided a video processing apparatus including: a telop detecting unit configured to detect telops displayed in an entered video; a telop selecting unit configured to select specific telops which satisfy arbitrary conditions from among the telops; a corresponding unit configured to acquire the specific telops within an arbitrary time range as one group from among the plurality of specific telops and the two of the specific telops from the group; a segment extracting unit configured to extract a specific segment interposed between the two of the specific telops; and an output unit configured to output the extracted specific segment.

According to the embodiments of the invention, detection of the specific segment which cannot be detected only by detection of the time telops is achieved.

### BRIEF DESCRIPTION OF THE DRAWINGS

FIG. 1 is a block diagram showing a configuration of a video processing apparatus according to a first embodiment of the invention;

FIG. 2 is a flowchart showing an operation of the video processing apparatus according to the first embodiment;

FIG. 3 is a drawing for explaining a problem in the related art.

FIG. 4 is a conceptual drawing for explaining a basic idea in the invention;

FIG. 5 is a block diagram showing a first configuration example of a telop selecting unit;

FIG. 6 is a block diagram showing a second configuration example of the telop selecting unit;

FIG. 7 is a drawing for explaining a process in the second configuration example of the telop selecting unit;

FIG. 8 is a block diagram showing a first configuration example of a corresponding unit;

FIG. 9 is a drawing for explaining a process of the corresponding unit in the first configuration example;

FIG. 10 is a block diagram showing a second configuration example of the corresponding unit;

FIG. 11 is a drawing for explaining a process in the second configuration example of the corresponding unit;

FIG. 12 is a block diagram showing a third configuration example of the corresponding unit;

FIG. 13 is a drawing for explaining a process of the corresponding unit in the third configuration example;

FIG. 14 is a block diagram showing a fourth configuration example of the corresponding unit;

FIG. 15 is a drawing for explaining a process of the corresponding unit in the fourth configuration example;

FIG. 16 is a drawing for explaining a process in an overlapped segment;

FIG. 17 is a flowchart showing the process in the overlapped segment;

FIG. 18 is a block diagram showing a configuration of a video processing apparatus according to a second embodiment;

FIG. 19 is a flowchart showing an operation of the video processing apparatus according to the second embodiment;

FIG. 20 is a drawing for explaining estimation of a specific segment;

FIG. 21 is a block diagram showing a configuration of a video processing apparatus according to a third embodiment;

FIG. 22 is a flowchart showing an operation of the video processing apparatus according to the third embodiment;

FIG. 23 is a drawing for explaining the estimation of a specific segment according to the third embodiment;

FIG. 24 is another drawing for explaining the estimation of a specific segment according to the third embodiment;

FIG. 25 is a drawing for explaining the estimation of a specific segment according to a first modification;

FIG. 26 is a drawing for explaining the estimation of a specific segment according to a second modification; and

FIG. 27 is another drawing for explaining the estimation of a specific segment according to the second modification.

### DETAILED DESCRIPTION OF THE INVENTION

Referring now to the drawings, a video processing apparatus 100 according to embodiments of the invention will be described.

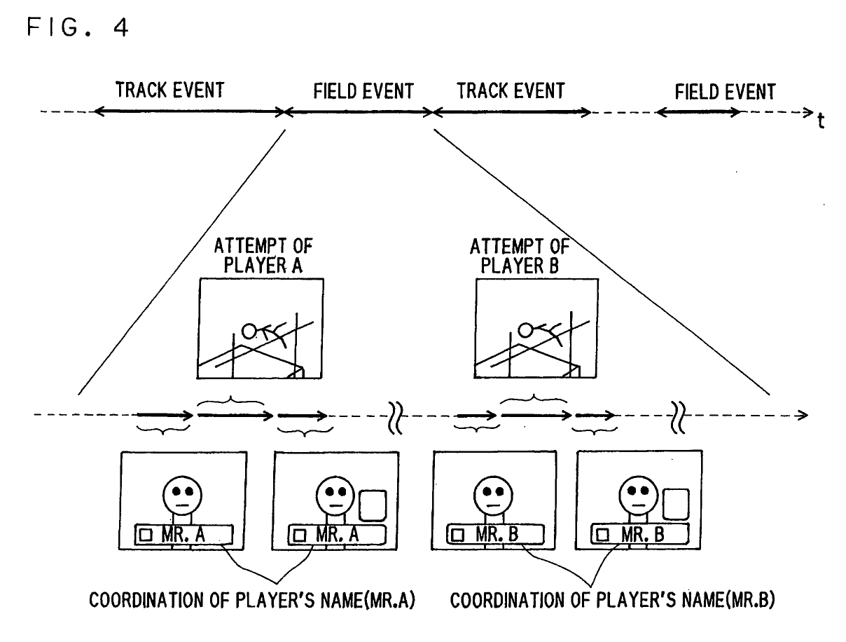

The video processing apparatus 100 in the embodiments detects play segments from player's name telops displayed before and after respective attempts without using time telops. As shown in FIG. 4, in the field events, a pattern of displaying a player's name with a telop indicating a record in the past before the attempts and displaying the player's name again with the result of the corresponding attempts after the attempts is used in many cases. Therefore, a group of the player's name telops of the same person is detected, and the specific segment interposed therebetween is detected as an attempts segment, so that the play segment of the field event is extracted.

Such telops are used in sports programs other than the track and field, or programs of categories other than the sports, such as music or comedy programs. According to the embodiments of the invention, extraction of specific segments is achieved in general programs in which telops displayed before and after a specific segment so as to interpose the same are used as described above.

### First Embodiment

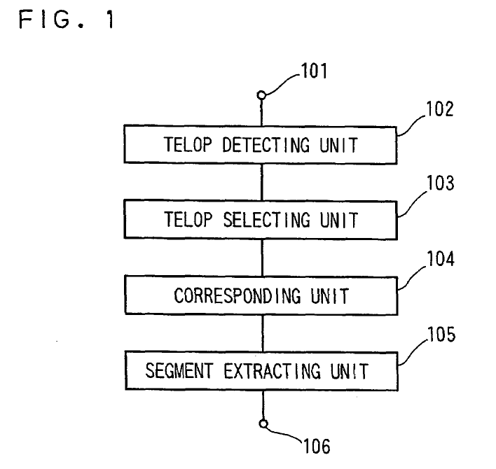

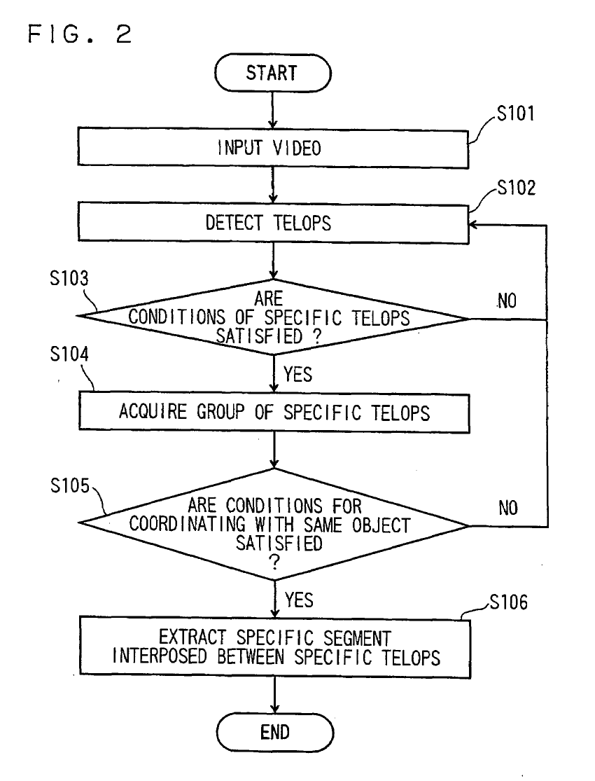

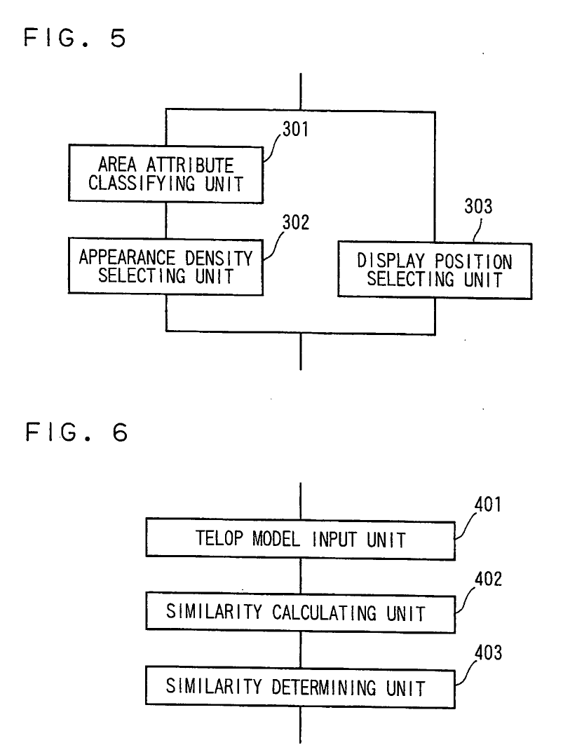

Referring now to FIG. 1 and FIG. 2, FIG. 5 to FIG. 17, the video processing apparatus 100 according to a first embodiment of the invention will be described.

### (1) Configuration of Video Processing Apparatus 100

The first embodiment is described shown in FIG. 1

The video processing apparatus 100 includes an input unit 101, a telop detecting unit 102, a telop selecting unit 103, a corresponding unit 104, a segment extracting unit 105, and an output unit 106.

The video processing apparatus 100 may also be realized by using a general-purpose computer as basic hardware, for example. In other words, the video processing apparatus 100 may be realized by causing the telop detecting unit 102, the telop selecting unit 103, the corresponding unit 104, the segment extracting unit 105, and a processor mounted on the computer to execute a program. At this time, the video processing apparatus 100 may be realized by installing the program in the computer in advance, or may be realized by storing the same in storage medium such as a CD-ROM or by distributing the program via a network and installing the program in the computer as needed.

The telop detecting unit 102 detects telops displayed in a video entered by the input unit 101. The term “telop” is not limited to characters, but indicates characters or images combined on a screen. Images which do not include characters such as logos are also referred to as the telops.

The telop selecting unit 103 selects telops which satisfy arbitrary conditions from among the detected telops as specific telops. The term “specific telops” indicate telops which serve as indices for detecting the specific segments, and are displayed before and after the specific segments so as to interpose the same therebetween. For example, telops indicating players' names or records displayed before and after attempts in a sport video correspond to the specific telops. The specific telops are not limited to those in the sport video, but telops displayed before and after respective songs in music programs or before and after appearances of respective comic entertainers in laugh-in programs in which respective entertainers present comedy stories in sequence are also included in the specific telops.

The corresponding unit 104 acquires specific telops included within an arbitrary time range from among the selected specific telops as a group, and two of the specific telops from the group are corresponded.

The segment extracting unit 105 extracts a specific segment interposed between the corresponded two specific telops and outputs the same from the output unit 106.

### (2) Operation of Video Processing Apparatus 100

Referring now to FIG. 1 and FIG. 2, an operation of the video processing apparatus 100 will be described.

### (2-1) Step S101

In Step S101, the video processing apparatus 100 acquires images (frames) as components of a video in sequence from the input unit 101. The acquired images are sent to the telop detecting unit 102. In this specification, the term “video” means a series of images (a series of frames) in time sequence, and the term “image” means one frame.

### (2-2) Step S102

Subsequently, in Step S102, the telop detecting unit 102 determines whether an image area which is estimated as a telop is present or not and, if the image area which is estimated as a telop is present, calculates its coordinate group.

The telop detecting unit 102 sends data on the image area which is estimated as the telop to the telop selecting unit 103.

As a method of determining the presence or absence of the image area which is estimated as a telop and the image, for example, methods disclosed in Japanese Patent No. 3655110 or in JP-A-2007-274154 (KOKAI) may be employed. However, the mode of realization of the first embodiment is not limited by the method of detecting the telop, and the first embodiment may be realized using other methods of detecting the telop.

The area which is estimated as the telop may be characters, or may include a decorative area in the periphery thereof displayed together with the characters. This area may be those other than the characters, such as logos or illustrations.

### (2-3) Step S103

Subsequently, in Step S103, the telop selecting unit 103 determines whether the received data satisfies conditions as the specific telop or not.

The specific telop selected by the telop selecting unit 103 is sent to the corresponding unit 104.

### (2-4) Step S104

Subsequently, in Step S104, the corresponding unit 104 acquires a plurality of specific telops within an arbitrary temporal range as one group.

A first example of the condition within the arbitrary temporal range will be described. Assuming that a specific telop positioned at the i^{th} position from the beginning of the video is expressed by Ti, by using a parameter n, specific telops included from the Ti to Ti+n are determined as telops which satisfy the condition. In other words, when n=1, adjacent specific telops, and when n=2, the adjacent specific telops and the next specific telop are acquired as one group.

As a second example, specific telops included from Ti within the range of time t are acquired as one group.

Also, examples shown as the first example and the second example may be combined in the form of EITHER-OR operation (OR) or AND operation (AND).

These conditions are shown as examples only, and do not limit the embodiments.

### (2-5) Step S105

Subsequently, in Step S105, the corresponding unit 104 determines whether the respective specific telops included in one group are corresponded to the same object or not is determined on the basis of conditions shown blow. Then, combinations of the corresponded specific telops are sent to the segment extracting unit 105.

### (2-6) Step S106

In Step S106, the segment extracting unit 105 extracts a specific segment interposed between the combination of the specific telops, for example the two of the specific telops. And the segment extracting unit 105 outputs the same from the output unit 106.

The specific segment extracted at this time may include a segment in which the specific telop is displayed and segments before and after as needed. For example, the segment extracting unit 105 extracts a segment from a cut point (where the scene is switched) just before the appearance of the initial specific telop to a cut point just after the disappearance of the final specific telop.

Also, a plurality of the specific segments may be combined. For example, after having detected the individual attempts segments of the sport, these attempts0 segments are combined as a play segment.

### (3) First Configuration Example of Telop Selecting Unit 103

The telop selecting unit 103 includes an area attribute classifying unit 301, an appearance density selecting unit 302, and a display position selecting unit 303 as shown in FIG. 5.

The area attribute classifying unit 301 classifies the telops on the basis of the attributes of the areas estimated as telops. The attributes include, for example, the color, the position, the size, and the time of appearance.

The appearance density selecting unit 302 calculates the appearance densities of the groups of the telops classified by the area attribute classifying unit 301, and selects the telops in a group having an appearance density higher than an arbitrary threshold value, or selects the telops in descending order from the group having the highest appearance density. For example, when the number of times of appearance during the time length td is N times, the appearance density is calculated by N/td.

The display position selecting unit 303 selects the telop on the basis of the position where the telop is displayed. For example, the display position selecting unit 303 selects an area which is estimated as the telop, the coordinate group of which is included within an arbitrary range in a screen.

The results of selection by the appearance density selecting unit 302 and the display position selecting unit 303 may be used in combination in the form of EITHER-OR operation or AND operation. It is also possible to employ one of these results. When employing only one of these results, the telop selecting unit 103 may include only the area attribute classifying unit 301 and the appearance density selecting unit 302, or only the display position selecting unit 303.

### (4) Second Configuration Example of Telop Selecting Unit 103

The telop selecting unit 103 includes a telop model input unit 401, a similarity calculating unit 402, and a similarity determining unit 403, as shown in FIG. 6.

The telop model input unit 401 enters a model which represents characteristics of the specific telop. For example, when the specific telops have a common use of color or decoration, the telop model input unit 401 uses a model of an image data on the basis of these characteristics as a template, or when the position and the size are known, the telop model input unit 401 uses a model on the basis of the coordinate group thereof. In the case of the model using the image data, either the colors of the respective pixels or the like as-is, density of the edge obtained by Sobel filter or the like, or histogram data indicating the distribution of colors may be used. It is also possible to express the model in methods other than those shown above.

The similarity calculating unit 402 calculates a difference which is a similarity between the telop model entered into the telop model input unit 401 and the telop detected by the telop detecting unit 102. For example, when the telop model is an image data, ΣxΣyd(x, y) is the similarity, where d(x, y) is the difference in pixel value from the detected telop at a coordinate (x, y). Here, ΣxΣy means to repeatedly add the latter term, that is, d(x, y), for all the combinations of x and y in an overlapped area between the telop model and the detected telop. d(x, y) may be, for example, d(x, y)=(V0(x, y)−Vi(x, y))². Here, V0(x, y) is the luminance of the image data of the model at the coordinate (x, y) and Vi(x, y) is the luminance of the image data of the detected telop.

The similarity determining unit 403 determines whether the similarity calculated by the similarity calculating unit 402 exceeds an arbitrary threshold value or not and, if yes, determines the detected telop as the specific telop.

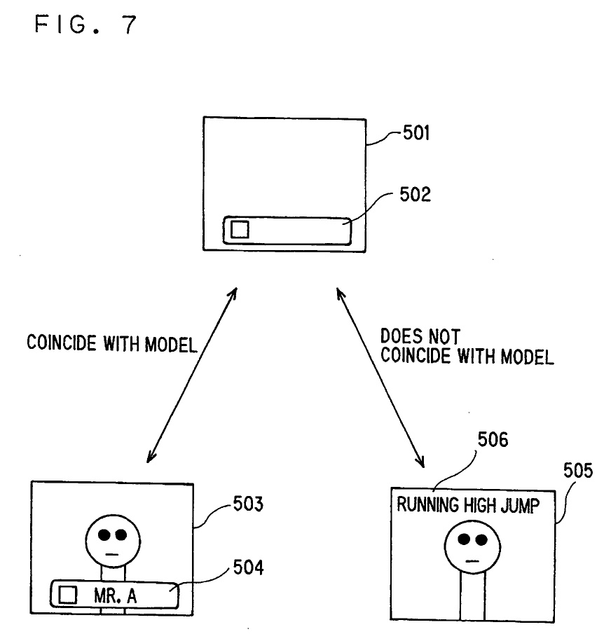

A frame 501 which includes a telop area 502 including decoration or the like in the vicinity of the specific telop is assumed to be a telop model, as shown in FIG. 7. When this telop model is compared with a video frame 503 including a telop 504, since the similarity of the telop areas is high, the telop 504 is determined to match the telop model and is selected as a specific telop. In contrast, when it is compared with a video frame 505 including a telop 506, since the similarity of the telop areas is low, the video frame 505 is determined not to match the telop model and is not selected as a specific telop.

It is also applicable to enter a telop model which is prepared in advance. It is also applicable to prepare a telop model from specific telops selected in a front half of the specific segment of a video by employing the first configuration of the telop selecting unit 103, and process the latter half of the specific segment using the second configuration.

Alternatively, when the color or the size of the specific telop to be detected is known in advance, the processes in the telop detecting unit 102 and the telop selecting unit 103 may be performed at the same time. In other words, when the similarities between the model of the specific telop to be detected and the respective video frames are calculated and, when the similarity exceeds an arbitrary value, it may be determined that there is a telop and the telop is a specific telop.

### (5) First Configuration Example of Corresponding Unit 104

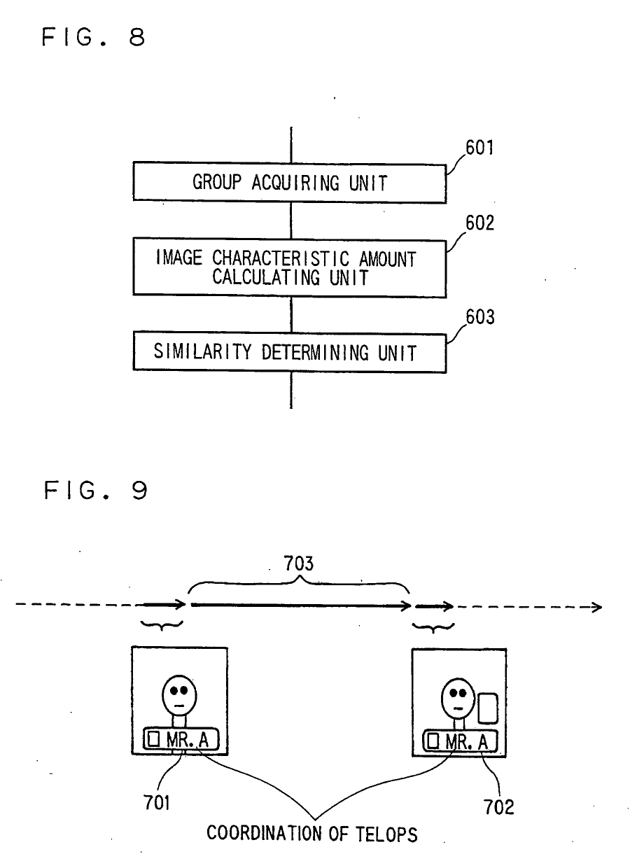

The corresponding unit 104 includes a group acquiring unit 601, an image characteristic amount calculating unit 602, and a similarity determining unit 603, shown in FIG. 8.

The group acquiring unit 601 selects at least two specific telops, and when they are within an arbitrary temporal range, obtains them as one group.

The image characteristic amount calculating unit 602 calculates the image characteristic amounts of the individual specific telops in this group.

The similarity determining unit 603 calculates the similarities which indicate how the respective specific telops are different from each other on the basis of the image characteristic amounts, and determines whether the similarities are larger than the arbitrary threshold value or not. When the similarity is larger than the arbitrary threshold value, it is determined that the specific telop is coordinated with the same object.

The configuration of the corresponding unit 104 is intended to determine whether the contents of the specific telop are the same or the equivalent thereto. Therefore, the image characteristic amounts to be calculated by the image characteristic amount calculating unit 602 may be any type as long as it achieves the object.

A first example is to use the respective pixel values of the area which is estimated as the specific telop as-is as the characteristic amounts. The similarity at this time is the sum of the differences of the respective pixel values in the entire area.

A second example is to use the calculated edge intensities, the color histogram distribution in the area, or signs which indicate whether the respective pixels have larger of smaller values than the adjacent pixel instead of using the pixel values as-is.

A third example is to use text data converted from image data by recognizing character portions by OCR as the image characteristic amount. The calculation of the similarity in this case is performed by text data matching.

It is assumed that specific telops 701 and 702 are acquired by the group acquiring unit 601, as shown in FIG. 9. At this time, when the image characteristic amounts of the specific telops 701 and 702 calculated by the image characteristic amount calculating unit 602 is determined to be similar (similarity is high) by the similarity determining unit 603, a specific segment 703 interposed between these specific telops 701 and 702 is extracted by the segment extracting unit 105.

### (6) Second Configuration Example of Corresponding Unit 104

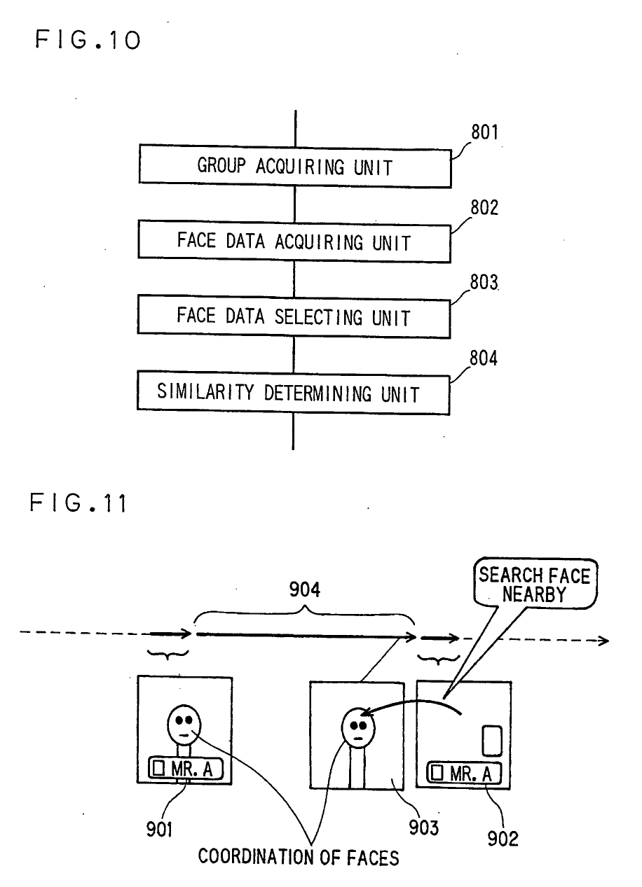

The corresponding unit 104 includes a group acquiring unit 801, a face data acquiring unit 802, a face data selecting unit 803, and a similarity determining unit 804, shown in FIG. 10.

The group acquiring unit 801 selects at least two specific telops, and when they are within an arbitrary temporal range, obtains them as one group.

The face data acquiring unit 802 acquires face data appeared in the video. As an example of the face data to be acquired, there is the position of the face or the coordinate group indicating characteristic points. Data such as the color or the orientation of the face may also be included. A method of acquisition may be an existing face detection method, or face data acquired by any other method in advance may be entered. The specific segments for acquiring the face data do not necessarily have to be the entire video, and only the face data appeared within an arbitrary time range may be acquired from the specific telops which are to be coordinated.

In order to correspond the specific telops, the face data selecting unit 803 selects the face data which indicates the characteristic amounts of the faces appeared in the images having the specific telops for the respective specific telops included in the group.

However, there is a case in which the image having the specific telop has no face included therein. In such a case, the face data of a face appeared in an image which is temporarily near the image having the specific telop is selected. For example, the face data to be selected is obtained from a frame which is temporarily nearest to the time of appearance of the specific telop to be corresponded. Alternatively, the face appeared in the image immediately before the appearance of the specific telop may be used.

Still alternatively, the face which faces the most front, the largest face, or the face positioned at the center of the screen may be employed from among those included in the temporary specific segment in which the specific telop is displayed.

The similarity determining unit 804 calculates the similarities of the characteristic amounts of the faces which indicate how different the faces selected by the face data selecting unit 803 are, and determines whether the similarities are smaller than an arbitrary threshold value or not. When the similarities are smaller than the arbitrary threshold value, it is determined that the specific telop is coordinated with the same object.

The group acquiring unit 801 acquires specific telops 901 and 902. At this time, a face is included in the video frame in which the specific telop 901 is displayed, and no face is included in the video frame in which the specific telop 902 is displayed, as shown in FIG. 11.

Therefore, the face data selecting unit 803 acquires the face displayed just before the appearance of the specific telop 902 from a video frame 903.

When the characteristic amounts are similar to an extent that the two faces are determined to be of the same person, the similarity determining unit 804, and the specific telops 901 and 902 are coordinated, and a specific segment 904 interposed therebetween in the segment extracting unit 105 is extracted.

### (7) Third Configuration Example of Corresponding Unit 104

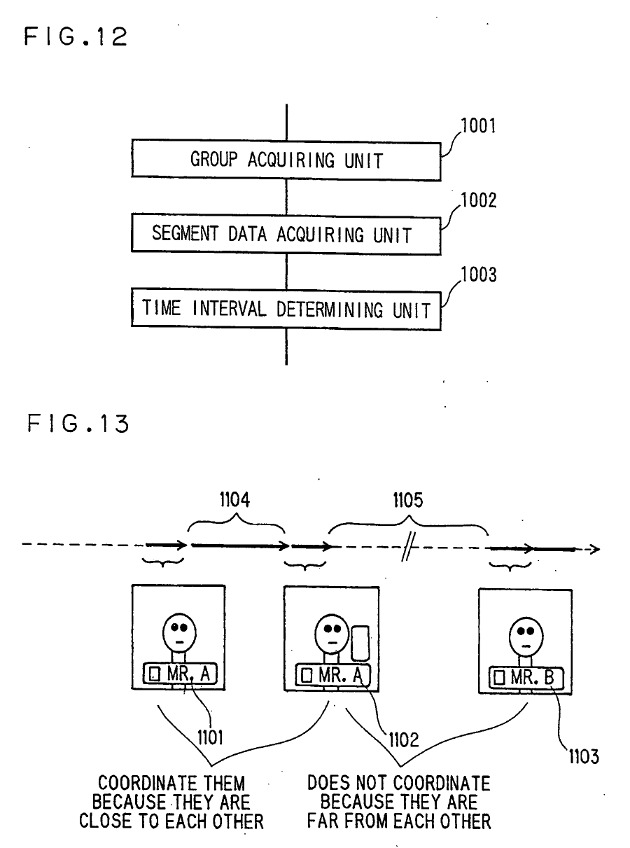

The corresponding unit 104 includes a group acquiring unit 1001, a segment data acquiring unit 1002, and a time interval determining unit 1003, as shown in FIG. 12.

The group acquiring unit 1001 selects at least two specific telops, and when they are within an arbitrary temporal range, obtains them as one group.

The segment data acquiring unit 1002 acquires segment data of respective specific telops included in the group. For example, the segment data is a time when the telop is appeared, or the time when the telop is disappeared. It is also applicable to use the time such as a midpoint calculated from such data.

The time interval determining unit 1003 calculates a time interval which indicates how the specific telops included in one group are away from each other on the basis of the segment data, and when the time interval satisfies arbitrary conditions, it is determined that the specific telops are corresponded to the same object. The determination on the basis of the arbitrary conditions is such that, for example, when the time interval between the telops to be corresponded is the closest in comparison with the time interval with other telops, the corresponding time interval is determined to satisfy the conditions, or when the time interval between the telops is smaller than an arbitrary threshold value, the corresponding time interval is determined to satisfy the conditions.

The group acquiring unit 601 acquires a group of specific telops 1101 and 1102 and a group of specific telops 1102 and 1103. At this time, the time interval determining unit 1003 calculates the time interval of a specific segment 1104 and the time interval of a specific segment 1105 from the respective segment data obtained by the segment data acquiring unit 1002, as shown in FIG. 13.

Then, since the time interval of the specific segment 1104 is shorter than that of the specific segment 1105, the specific telops 1101 and 1102 are coordinated, and the segment extracting unit 105 extracts the specific segment 1104 interposed therebetween.

### (8) Fourth Configuration Example of Corresponding Unit 104

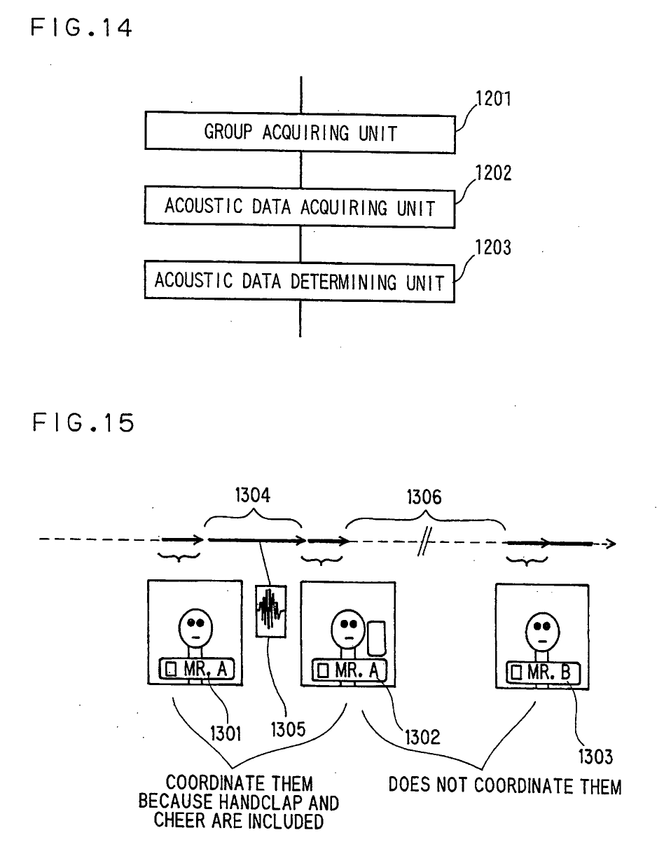

The corresponding unit 104 includes a group acquiring unit 1201, an acoustic data acquiring unit 1202, and an acoustic data determining unit 1203, as shown in FIG. 14.

The group acquiring unit 1201 selects at least two specific telops, and when they are within an arbitrary temporal range, obtains them as one group.

The acoustic data acquiring unit 1202 acquires acoustic data of the specific segment interposed between the respective specific telops included in the group. The acoustic data means acoustic signals or speech signals. It may be raw acoustic signals incidental on the video. It also may be data on the characteristic amounts obtained by analyzing the acoustic signals, for example, frequency data or an acoustic power (volume of sound), cepstrum, MFCC (Mel-Frequency Cepstrum Coefficient). Alternatively, it may be semantic data obtained by analyzing the acoustic signals. The analysis includes whether the specific frequency component is included or not, matching with a specific acoustic model, speech recognition and the like. Such data includes, for example, data indicating whether the acoustic signals are a cheer, a handclap, a talking voice, a shout in throwing events, a singing voice, music or not. Such analyzing process may be performed in the acoustic data acquiring unit 1202, or may not be performed and data may be supplied from the outside.

The acoustic data determining unit 1203 determines whether the acoustic data satisfies arbitrary conditions, and when it satisfies, the specific telops which interpose the specific segment from which the acoustic data is acquired are corresponded with the same object. Examples of such conditions will be described below.

A first condition is whether the distribution is similar to an arbitrary pattern, such that a specific frequency component in the frequency data is high.

A second condition is the characteristic amount such that whether the acoustic power is larger than an arbitrary threshold value or not.

A third condition may be contents attached with meaning such that whether the acoustic signals are a cheer, a handclap, a talking voice, a shout of a player in throwing events, a singing voice, music or not.

As shown in FIG. 15, The group acquiring unit 1201 acquires a group of specific telops 1301 and 1302 and a group of specific telops 1302 and 1303. At this time, since an acoustic signal 1305 which satisfies arbitrary conditions such as a handclap or a cheer is included in a specific segment 1304 between the specific telops 1301 and 1302, the specific telops 1301 and 1302 are coordinated.

However, since no acoustic signal which satisfies the arbitrary conditions is included in a segment 1306 between the specific telops 1302 and 1303, the specific telops 1302 and 1303 are not corresponded.

Consequently, the segment extracting unit 105 extracts the specific segment 1304.

### (9) Modification of Fourth Configuration Example of Corresponding Unit 104

A modification of the fourth configuration example of the corresponding unit 104 will be described.

The same advantages as the corresponding unit 104 in the fourth configuration example are achieved using the image characteristic amounts instead of the acoustic signals.

The scenes of the attempts are shot at the same camera angle or camera work in many cases. The actions of the players are not much different. Therefore, whether to be performed corresponding the specific telops may be determined depending on whether the image characteristic amount which satisfies an arbitrary condition relating to the attempts is included in the specific segment between the specific telops or not. (10) Modifications of Corresponding unit 104

Modifications of the first to fourth configuration examples of the corresponding unit 104 will be described.

In the sport, there are cases in which a telop which indicates the player's name is displayed not only before and after the attempts, but also when the player appears in the screen during intermission, for example. If the specific telop is coordinated in such a case, the specific segment which is not the attempts is extracted. Therefore, a telop indicating a record displayed with the telop of the player's name is also included as a specific telop, and only the specific telops in which the telop indicating the record is changing are corresponded. It is because if the telop indicating the record is changing, it is estimated that the attempt is done during that period. Also, by extracting only the specific segment in which the telop of the player's name is the same and the record is changing in sequence, only the attempts of the specific player can be extracted as continuous attempts.

For corresponding the telops of the player's name, the first to fourth configuration examples of the corresponding unit 104 are used. In order to detect the fact that the telop of the record is changing, the fact that no corresponding the telops is done by the corresponding unit 104 in the first configuration example may be detected.

Also, the telop selecting unit 103 is able to select the specific telop on the basis of whether the telop is attached with the changing record. In other words, candidates of the specific telop are selected using the telop selecting unit 103 in the first configuration example or the second configuration example and, if they are attached with the changing record, they are determined as the specific telops.

### (11) When Specific Segments Overlap

With the process described thus far, the specific segments interposed between the specific telops belonging in the same group which is estimated to relate to the same object can be extracted. However, there may be a case in which a first group overlaps with the second group depending on the video.

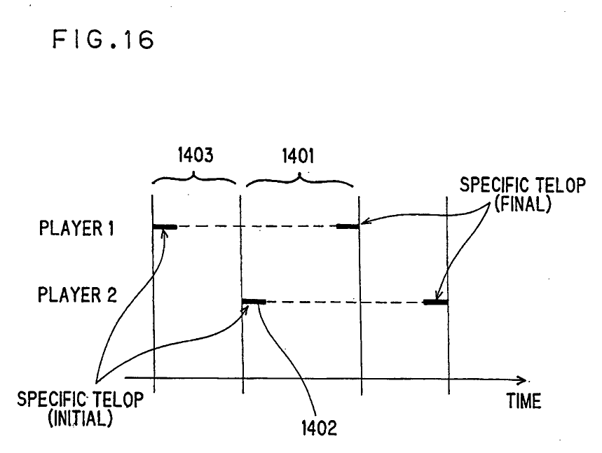

For example, it is a case such that an attempt of a first player is finished, and a next player starts his/her attempt before the result of the first player is given. In such a video, an initial telop of the second group appears prior to a final telop of the first group and hence an overlapped segment 1401 is resulted as shown in FIG. 16.

In such a case, since the second player is supposed to be appeared in the screen during a portion after a specific telop 1402, a specific segment 1403 before the overlapped segment 1401 is determined as a specific segment corresponding to the first player. The term “final telop” indicates a specific telop which defines the end point of the specific segment to be extracted in the group. In the same manner, the term “initial telop” indicates a specific telop which defines the beginning of the specific segment to be extracted in the group of the specific telops.

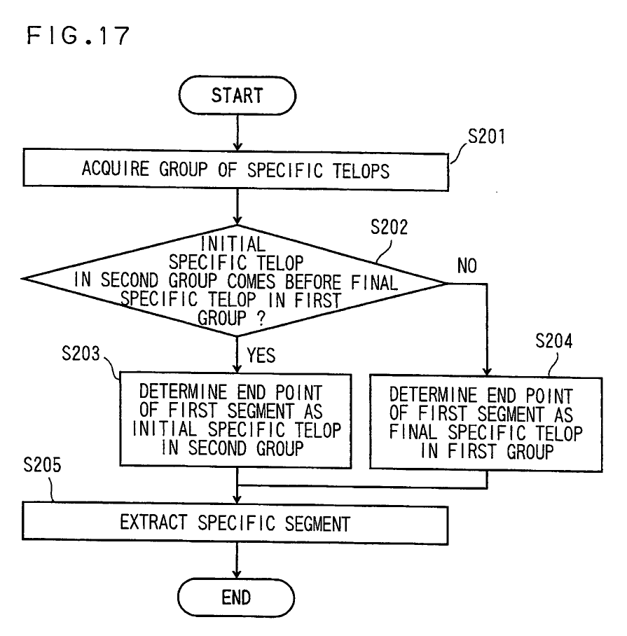

FIG. 17 is a flowchart of the process to be performed when the specific segments are overlapped with each other.

First of all, in Step S201, the corresponding unit 104 acquires two of the groups.

Then, in Step S202, the corresponding unit 104 compares the displayed times of the final telop in the first group and the initial telop in the second group.

Then, in Step S203, when the initial telop in the second group is positioned prior to the final telop in the first group, the final telop in the specific segment corresponds to the first group is determined as the initial telop in the second group by the corresponding unit 104.

If not, in Step S204, the corresponding unit 104 determines the final telop of the specific segment which corresponds to the first group as the final telop in the first group.

Finally, in Step S205, the corresponding unit 104 extracts a specific segment included between the initial telop in the first group and the final telop obtained in Step S203 or Step S204 as the specific segment corresponding to the first group.

Whether to include the segment of the specific telop itself in the specific segment to be extracted or not may be determined according to the object. It is also possible to include only one of those. For example, including only the initial telop but not the final telop is also applicable.

### Second Embodiment

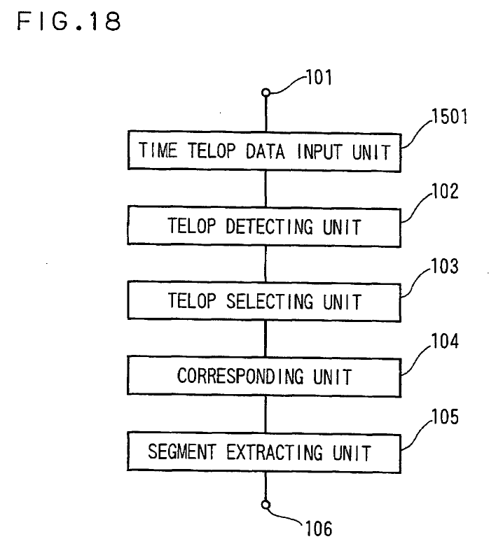

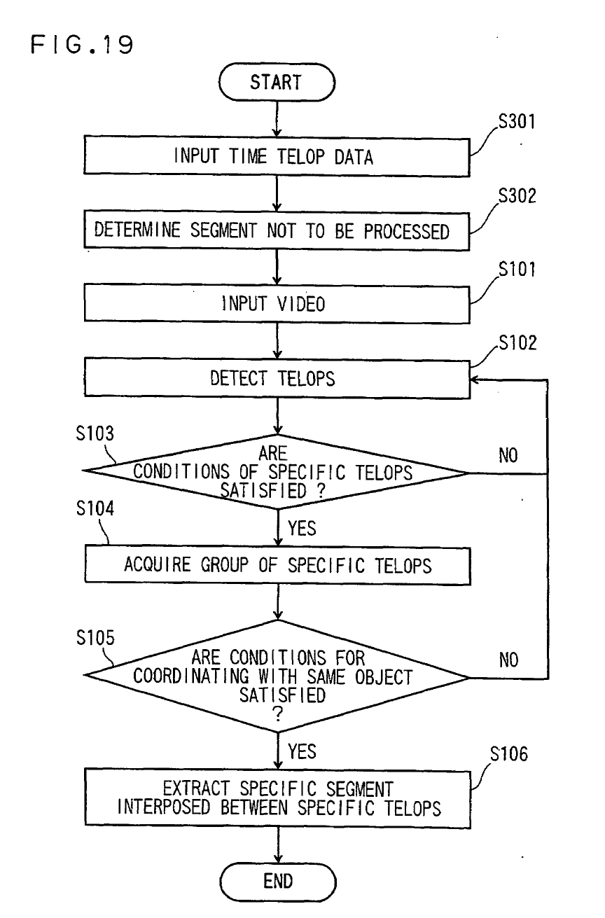

Referring now to FIG. 18 and FIG. 19, the video processing apparatus 100 according to a second embodiment of the invention will be described.

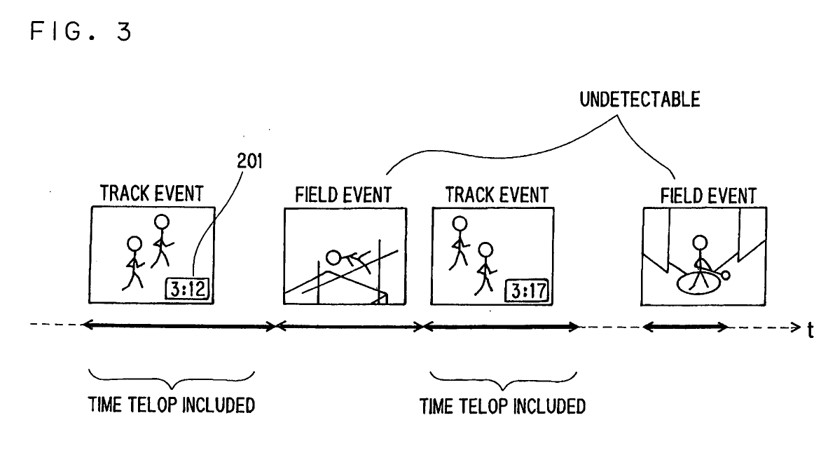

As shown in FIG. 3, in the sport, extraction of the specific segments according to the second embodiment has an interpolating relation with the extraction of the segment on the basis of a competition time telop 201. It is possible to extract the play segments of part of the events (for example, the track events in the filed and track) by detecting the time telop and extract the play segments of other events (for example, the field events in the track and field) by detecting the specific segment according to the second embodiment.

Therefore, in the second embodiment, segments in which the time telop is displayed or specific segments estimated as the play segments on the basis of the time telop are excluded for processing.

### (1) Configuration of Video Processing Apparatus 100

As show in FIG. 18, the video processing apparatus 100 includes a time telop data input unit 1501 in addition to the input unit 101, the telop detecting unit 102, the telop selecting unit 103, the corresponding unit 104, the segment extracting unit 105, and the output unit 106 as the components in the first embodiment.

The time telop data input unit 1501 inputs time telop data. The time telop may be detected by a method disclosed in JP-A-2008-72232 (KOKAI), for example.

Since other components are the same as those in the first embodiment, the detailed description will be omitted.

### (2) Operation of Video Processing Apparatus 100

Referring now to FIG. 18 and FIG. 19, the operation of the video processing apparatus 100 according to the second embodiment will be described. The difference from the operation of the video processing apparatus 100 according to the first embodiment is that the time telop data is entered from the time telop data input unit 1501 (S301), and segments in which the time telop is displayed on the basis of the time telop data or segments estimated as the play segments from the time telop are excluded from the object of processing (S302).

In the steps from then onward, Steps S101 to S106 are performed in the same manner as the video processing apparatus 100 according to the first embodiment only for the segments to be processed.

By using the video processing apparatus 100 according to the second embodiment, it is able to reduce the amount of calculation and restrain extraction of unintended segments appeared accidentally in the segments estimated from the time telop

### Third Embodiment

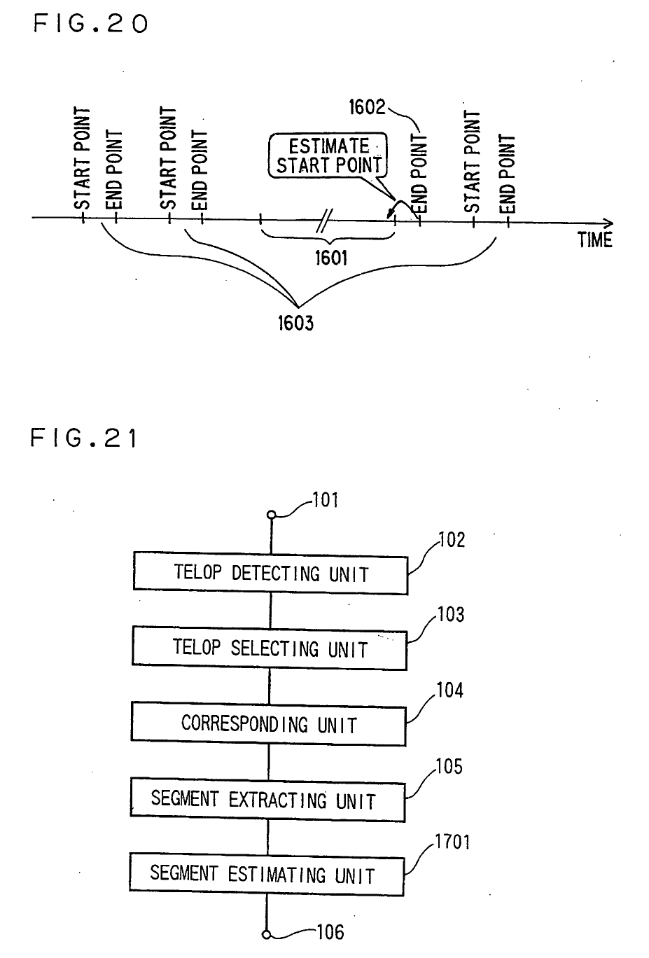

Referring now to FIG. 20 to FIG. 24, the video processing apparatus 100 according to a third embodiment of the invention will be described.

In the embodiments described above, segments which cannot be coordinated with the specific telop are not extracted. However, in actual programs, one of the initial telop and the final telop might not appear.

For example, when another video 1601 is inserted at some point of a television program of the track and field, there is a case in which the initial telop cannot be displayed on time even when a trial of a next player is started and only a final telop 1602 for displaying the record is displayed. The another video 1601 includes, for example, another event which is done at the same time, commercial messages, news given out between programs, and VTRs such as replay.

Therefore, in the third embodiment, the specific segment is estimated on the basis of a segment 1603 which is corresponded even in such a case.

### (1) Configuration of Video Processing Apparatus 100

As shown in FIG. 21, The video processing apparatus 100 includes a segment estimating unit 1701 in addition to the input unit 101, the telop detecting unit 102, the telop selecting unit 103, the corresponding unit 104, the segment extracting unit 105, and the output unit 106 as the components in the first embodiment.

The segment estimating unit 1701 estimates a specific segment corresponding to a telop which is failed to be corresponded on the basis of the data on the specific telop corresponded by the corresponding unit 104.

Since other components are the same as those in the first embodiment, the detailed description will be omitted.

### (2) Operation of Video Processing Apparatus 100

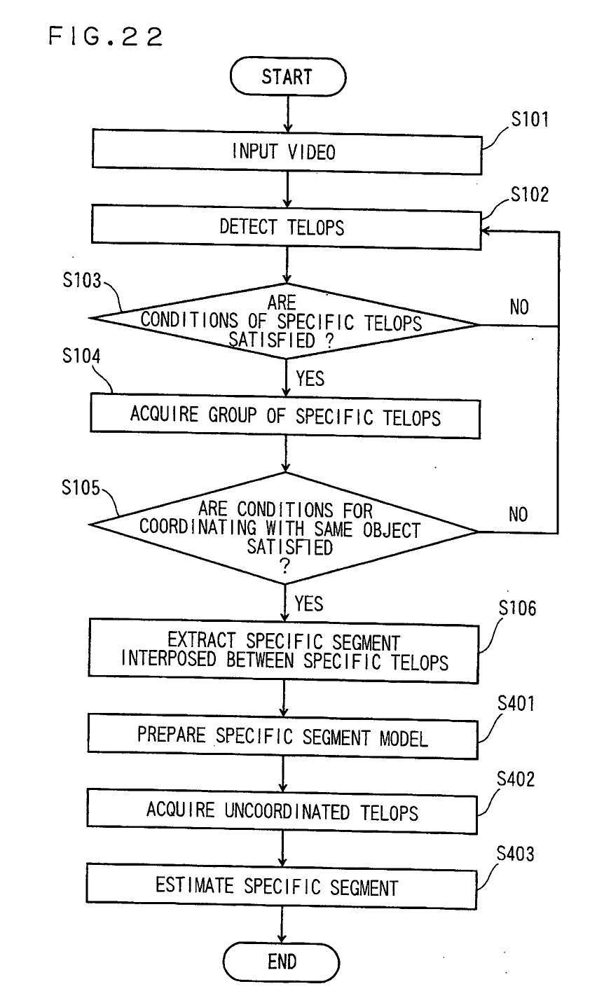

Referring now to FIG. 21 and FIG. 22, the operation of the video processing apparatus 100 will be described. First of all, the processes in Step S101 to S106 are carried out in the same manner as the video processing apparatus 100 according to the first embodiment.

Subsequently, in Step S401, the segment estimating unit 1701 prepares a specific segment model on the basis of the segment data extracted by the segment extracting unit 105. The term “specific segment model” is, for example, the average time length of the specific segment, or the characteristic amounts of image or acoustic sound in specific segments from the initial telop to the final telop (which may include sections before and after. The sections included pluralities of frames in spit of including the telop).

Subsequently, in Step S402, the segment estimating unit 1701 acquires the specific telop which is failed to be coordinated by the corresponding unit 104. For example, it is the telop which is indicated as “end point” designated by reference numeral 1602 in FIG. 20.

Finally, in Step S403, the segment estimating unit 1701 estimates a specific segment corresponding to the specific telop acquired in Step S402 on the basis of the specific segment model prepared in Step S402.

### (3) Operation of Segment Estimating Unit 1701

Detailed examples of the method of estimating the specific segment in Step S403 by the segment estimating unit 1701 will be described.

A first method is such that the average time length is used as the specific segment model, and the specific telop acquired in Step S402 is determined whether it is an initial telop or a final telop for each video. Then, a segment which ends at the average time length after the initial telop is estimated as specific segment (when finding the end point), or which starts at the same time length before the final telop is estimated as specific segment (when finding the start point).

A second method is such that the characteristic amounts of images or acoustic sounds extracted from a part or the entire range of the specific segments from the initial telop to the final telop (which may include sections before and after the telop) are used as the specific segment model. For example, since images displayed when the players are about to start each attempts or images during the attempts are estimated to be similar images every time, data on luminance, color, and movement from these scenes are employed as the characteristic amounts. Then, a portion having a similar image characteristic amount is searched near the specific telops acquired in Step S402 to estimate the specific segment to be extracted. A case in which the speech is used is also the same. The timing when a hand clap, a cheer or the like occurs is estimated to be similar from one attempt to another attempt even when the player is different. Therefore, portions having similar acoustic characteristic amounts are searched to estimate the specific segment.

The first method and the second method may be combined. For example, whether the specific telop corresponds to the initial telop or the final telop is estimated using the scene of the attempt and the characteristic amounts of the hand clap and the cheer, and whether the time is to be advanced or reversed by the average time length is determined on the basis of the result thereof.

### (4) Other Examples

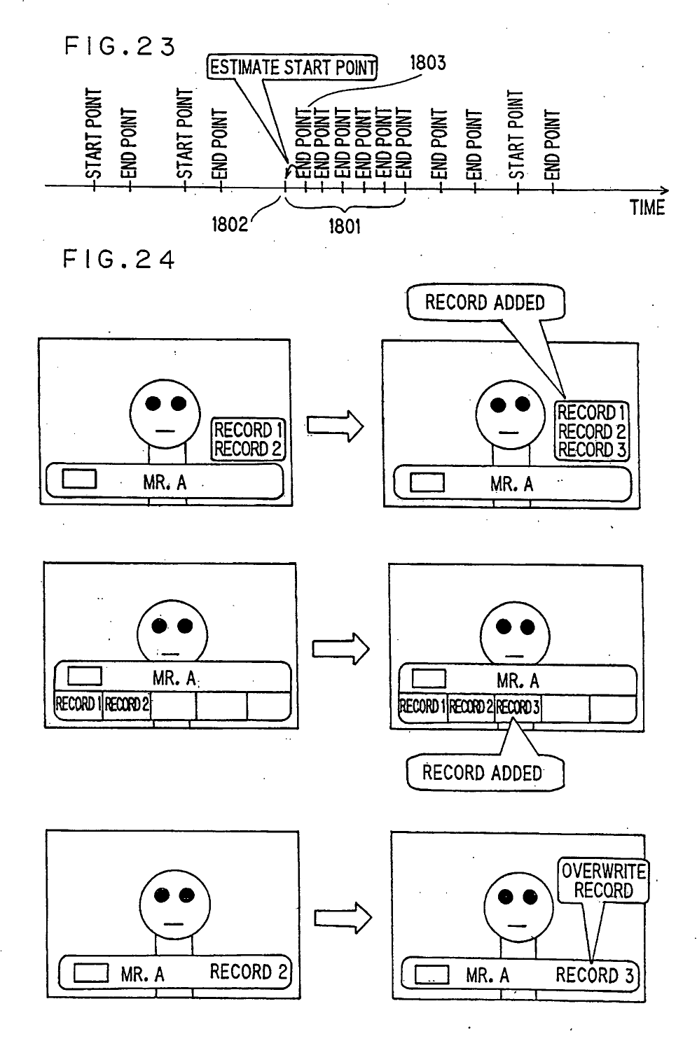

As shown in FIG. 23, a case in which attempts 1801 by a plurality of times are broadcasted together as a digest is exemplified. Since only the videos of the attempts and the specific telops (final telops) including the records thereof are displayed in sequence, the specific telops which cannot be corresponded appears consecutively during the corresponding specific segment.

In order to extract the attempts segments in such an example, specific telops which are failed to be corresponded having an interval with adjacent specific telops equal to or smaller than a threshold value are grouped, and when the elements in the group is equal to or larger than an arbitrary number, the specific segments interposed between the specific telops at a farthest time distance are extracted together as a attempt segment. Instead of the intervals, whether the number of times of appearance per hour (appearance density) exceeds an arbitrary number of times or not may be used as a criterion.

When the specific telops as such are compared at every attempt, the portion of the record is updated although only the portion of the player's name is the same. At this time, since the record portion is updated on the basis of a certain pattern, whether the partial area updated on the basis of the certain pattern is present in the specific telops or not is determined. If yes, the specific segment interposed between the specific telops at a farthest time distance are extracted together as an attempt segment. The partial area is found by obtaining inter-frame differences, or by detecting a newly appeared telop area.

There are three examples shown in the FIG. 24, and figures on the left side represent specific telops after the attempt finished just before, and figures on the right side represent specific telops after the attempt of this time, in which the “record 3” is added or overwritten newly.

In any of these methods of extracting the specific segments, when it is estimated that an initial specific telop 1802 in the first specific segment is omitted, estimation may be carried out using the segment estimating unit 1701. A method of estimating that the initial specific telop 1802 is omitted is achieved by determining whether the specific segment which is similar in characteristic amounts of video or acoustic sounds to the specific segments after a final specific telop 1803 (the specific segments interposed between the respective final telops) in the specific segment just before the telop 1803 at the beginning is present or not. If yes, it is estimated that the initial specific telop 1802 is omitted.

### (Modifications)

The invention is not limited to the embodiments shown above as-is, and components may be modified and embodied without departing from the scope of the invention in the stage of implementation. Various modes of the invention are achieved by combining the plurality of components disclosed in the embodiments described above as needed. For example, several components may be eliminated from all the components shown in the embodiments. In addition, the components in different embodiments may be combined as needed.

Modifications will be described later.

### (1) First Modification

In some programs or events, it takes a long time before the record is displayed after an attempt.

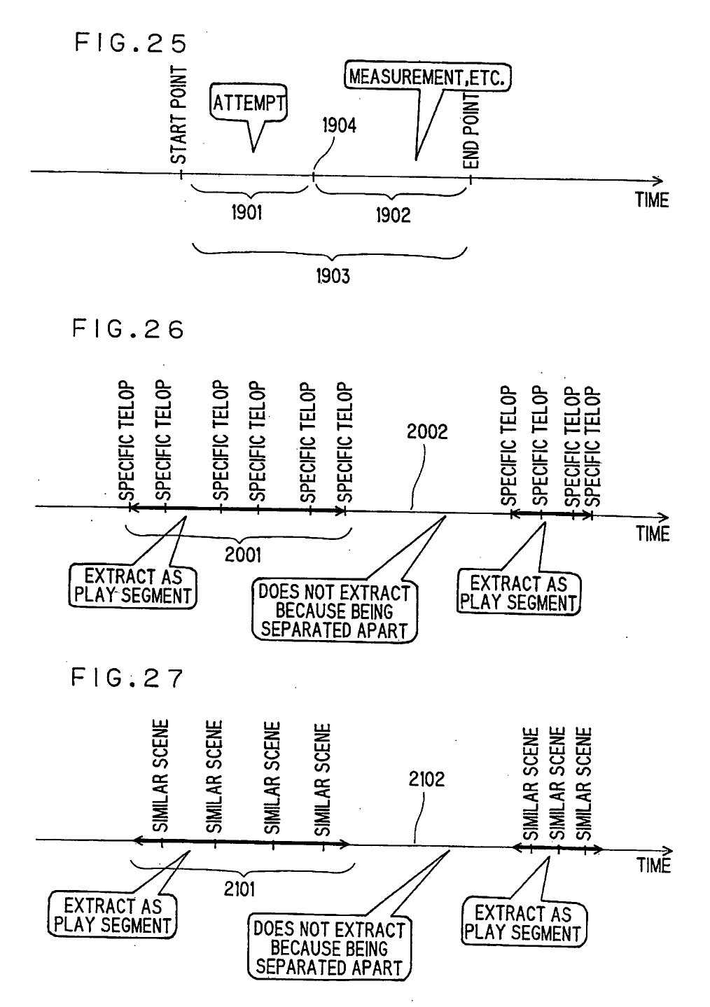

It is, for example, a case in which a time 1902 for measurement or determination of record, or aggregation of points exists after a time 1901 for an attempt as shown in FIG. 25. If the segment 1903 between the initial telop and the final telop in which the record is displayed is extracted as-is in such a video, many segments in which the trial is not made are unintentionally included.

Therefore, the video processing apparatus 100 according to the first modification extracts only part of the segment when the length of the segment between the initial telop and the final telop exceeds an arbitrary time length.

For example, the segment from the initial telop before a position 1904 which is an arbitrary time position is extracted. The position 1904 may be determined to be a certain value, may be determined on the basis of a value (average value, for example) obtained by statistically processing other segments (specific segments from the initial telop to the final telop), or may be determined from a ratio with respect to the segment 1903 (midpoint, for example).

### (2) Second Modification

Although the specific telops are coordinated and the attempt segment included therebetween is extracted in the video processing apparatus 100 according to the embodiments described above, when extracting the entire play segments together instead of the individual attempt segments, extract is achieved without carrying out the coordination. As shown in FIG. 26, since the specific telops appear intensively during the play segment, they are mal-distributed in view of the entire program.

Therefore, a segment in which telops estimated as specific telops exist (for example, 2001) is extracted in block as the play segment (but not extracted as the individual attempt segments) by the telop selecting unit 103. When the interval between adjacent specific telops is equal to or smaller than an arbitrary interval, these telops are included as a continuous play segment, and if the interval 2002 is long, it is not included in the play segment. The number of times of appearance per hour may be employed as a threshold value instead of the interval. In this case, a specific segment in which the number of times of appearance exceeds an arbitrary number is extracted as the play segments.

As shown in FIG. 27, specific segments in which similar scenes appear repeatedly may be determined as the play segments without using the specific telops. Generally, in scenes of attempts, the camera angle or the movement of players is similar in many cases, and hence similar scenes appear repeatedly.

Therefore, first of all, frames or scenes in a video are compared with each other and clusters of frames or scenes having similar characteristic amounts are prepared. Then, similar scenes are selected by selecting a cluster having the number of times of appearance per hour larger than an arbitrary value, or by selecting the clusters on the basis of the number of times of appearance in descending order in sequence.

Subsequently, when the intervals between the adjacent similar scenes are equal to or smaller than an arbitrary value, these scenes are included in a continuous play segment (for example, 2101), and when an interval 2102 is large, it is not included in the play segment, so that the specific segment is determined.

Alternatively, instead of using the similar scenes, the same effect is achieved also by employing scenes having similar movements over the entire screen caused by the movement of the camera (panning or zooming) or scenes including similar acoustic sounds or speeches.

### Third Modification

A third modification will be described.

In the video processing apparatus 100 according to the embodiments described above, description has been given mainly on the field events of the track and field. However, application of the video processing apparatus 100 in the embodiments described above are not limited to these events.

For example, it may generally be applied to sports which involve scoring such as ski (jump, mogul, etc.) or figure skating in the field.

Also, the video processing apparatus 100 is applicable to the sports to which detection of the time telop can be applied. For example, in the Alpine events of ski (events for competing time), the skier's name is displayed with the scene at the starting time, and the skier's name and his/her record are displayed when he/she crosses the finish line. In such types of sports, the time telop may be used, and the embodiments in the invention may also be used.

Alternatively, the video processing apparatus 100 may be applied to acting, musical performance, or lecture as other categories other than the sport. For example, in some music programs, the name of the singer and the name of the song are displayed as a telop at the beginning of the song, and displayed again at the end of the song. The video processing apparatus 100 is also applicable to such programs.

Also, it is applicable to variety programs (laugh-in programs), such as programs in which entertainers present their comedy stories in sequence and the names are displayed at the times of both appearance and termination of their comedy history.

In this manner, the video processing apparatus 100 is generally applicable to programs in which telops such as the name of the person or the group, the title, or the title of the song are displayed before and after acting, musical performance, or lecture.

What is claimed is:

1. A video processing apparatus comprising:
a telop detecting unit configured to detect telops displayed in an entered video;
a telop selecting unit configured to select specific telops which satisfy arbitrary conditions from among the telops;
a corresponding unit configured to acquire the specific telops within an arbitrary time range as one group from among the plurality of specific telops and the two of the specific telops from the group;
a segment extracting unit configured to extract a specific segment interposed between the two of the specific telops; and
an output unit configured to output the extracted specific segment.

2. The apparatus according to claim 1, wherein the telop selecting unit selects the specific telops on the basis of positions displayed in the video from among the plurality of telops.

3. The apparatus according to claim 1, wherein the telop selecting unit selects the specific telops on the basis of appearance density of the telops from among the plurality of telops.

4. The apparatus according to claim 3, wherein the appearance density of the telops employs the number of times of appearance per a given time.

5. The apparatus according to claim 1, wherein the telop selecting unit obtains similarities from differences between the telops and a telop model stored in advance and, when the similarities are equal to or larger than a first threshold value, selects the telops as the specific telops.

6. The apparatus according to claim 1, wherein the corresponding unit coordinates two of the specific telops which are temporarily adjacent to each other from among the specific telops in the group.

7. The apparatus according to claim 1, wherein the corresponding unit determines similarities of image characteristic amounts of the respective specific telops in the group and the two of the specific telops which are higher in the similarities than a second threshold value.

8. The apparatus according to claim 1, wherein the corresponding unit calculates characteristic amounts of faces appeared in images having the specific telops in the group, determines similarities of the characteristic amounts of the faces, and coordinates two of the specific telops which are higher in similarities than a third threshold value.

9. The apparatus according to claim 1, wherein the corresponding unit determines time intervals of two sets of the specific telops in the group and corresponds the two specific telops of a set having a shorter time interval.

10. The apparatus according to claim 1, wherein the corresponding unit corresponds the two of the specific telops interposing an arbitrary speech signal or acoustic signal in the group.

11. The apparatus according to claim 1, wherein when the specific segment interposed between the two of the specific telops in one such group is overlapped with the specific segment interposed between the two of the specific telops in another such group, the segment extracting unit extracts the specific segment by excluding the specific segment positioned temporarily after from the specific segment positioned temporarily before.

12. The apparatus according to claim 1, further comprising a time telop data input unit configured to detect a segment in which no time telop is displayed, wherein the telop detecting unit detects the telop from the segment in which the time telop is not displayed.

13. The apparatus according to claim 1, further comprising a segment estimating unit configured to estimate the specific segment relating to the telop which is failed to be coordinated on the basis of the data of the coordinated specific telop.

14. A video processing method comprising:
detecting telops displayed in an entered video;
selecting specific telops which satisfy arbitrary conditions from among the telops;
acquiring specific telops within an arbitrary time range as one group from among the specific telops and the two of the specific telops from the group;
extracting a specific segment interposed between the two of the specific telops; and
outputting the extracted specific segment.

15. A video processing program stored in a computer readable media, the program causing the computer to achieve functions of:
detecting telops displayed in an entered video;
selecting specific telops which satisfy arbitrary conditions from among the telops;
acquiring specific telops within an arbitrary time range as one group from among the plurality of specific telops and the two of the specific telops from the group;
extracting a specific segment interposed between the two of the specific telops; and
outputting the extracted specific segment.
